(19) United States
(12) Patent Application Publication
(10) Pub. No.: US 2008/0060335 A1
(43) Pub. Date: Mar. 13, 2008

(54) Machine for managing shoots of vines

(75) Inventor: Francis Edward O'Riley, Angle Vale (AU)

Correspondence Address: THE WEBB LAW FIRM, P.C., 700 KOPPERS BUILDING, 436 SEVENTH AVENUE, PITTSBURGH, PA, 15219, US

(73) Assignee: PELLENC AUSTRALIA PTY LTD, Magill (AU)

(21) Appl. No.: 11/900,655

(22) Filed: Sep. 12, 2007

(30) Foreign Application Priority Data
Sep. 12, 2006 (AU) 2006905066

(51) Int. Cl. A01G 3/08; A01G 17/00

(52) U.S. Cl. 56/234; 15/3

(57) ABSTRACT

A machine for managing shoots of vines arranged on a trellis, the machine comprising: a frame that has two spaced apart uprights, the frame being arranged to straddle the trellis, each upright supporting a brush that is rotatable to contact shoots extending from the vines; and a drive mechanism for imparting rotational motion to each brush, such that, in use, the brushes rotate on opposing sides of the trellis to contact and remove shoots from the vine as the machine is advanced along the trellis.

### FIELD OF THE INVENTION

The present invention relates to a machine for managing shoots of vines arranged on a trellis, and also to an elongate brush for use in thinning and/or removing shoots from the cordon and/or trunk of a vine.

### BACKGROUND

Training and pruning of vines are important activities in maintaining the productivity of a vineyard. Prior to the onset of grape growth, annual pruning is undertaken to sculpt each vine with the aim of optimizing fruit density, air circulation, and both light and spray penetration. Shoot thinning is a principal activity for optimizing fruit density. It is often desirable to remove substantially all basal shoots beside and/or beneath the cordon in early to mid spring, depending on the season.

A number of automated pruning devices for trained vines exist. However, automated shoot thinning around the cordon is notoriously difficult due to the need to remove the shoots at their base, adjacent the cordon. In addition, it is desirable that the shoots be removed cleanly and completely. This can be difficult as the shoots are supple rather than woody at the optimal time to remove the shoots.

### SUMMARY OF THE INVENTION

According to a first aspect of the present invention, there is provided a machine for managing shoots of vines arranged on a trellis, the machine comprising:

a frame that has two spaced apart uprights, the frame being arranged to straddle the trellis, each upright supporting a brush that is rotatable to contact shoots extending from the vines; and

a drive mechanism for imparting rotational motion to each brush, such that, in use, the brushes rotate on opposing sides of the trellis to contact and remove shoots from the vine as the machine is advanced along the trellis.

According to another aspect of the present invention, there is provided an elongate brush for thinning shoots from the cordon of a vine, the brush comprising:

a rotatable shaft supporting a plurality of mounts connected spaced apart to the shaft, the mounts providing support for a plurality of bristle sets each having bristles that extend from a bristle support,

wherein the bristle supports are releasably connected across the mounts and parallel to the shaft.

According to yet another aspect of the present invention, there is provided a brush comprising a rotatable shaft supporting an elongate bristle support helically wound around and secured to the shaft, the bristle support supporting an elongate array of laterally extending bristles.

The machine may additionally have a control system that senses the position of the cordon and operates the actuator assembly to adjust the horizontal of each brush, relative to the respective upright, in response to changes in the position of the vines and/or trellis.

The control system can sense the inclination of the cordon and operates the actuator assembly to adjust the vertical position of the rotational of each brush in response to changes in the vine and/or trellis height.

In some embodiments, the control system can sense the ground speed of the machine and adjust the rotational speed of the elongate brushes in response to changes in the ground speed.

### BRIEF DESCRIPTION OF THE DRAWINGS

In order that the invention may be more easily understood, embodiments will now be described, by way of example only, with reference to the accompanying drawings, in which:

FIG. 1: is a first schematic perspective view of a machine for managing shoots according to a first embodiment of the present invention;

FIG. 2: is a second schematic perspective view of the machine for managing shoots of FIG. 1;

FIG. 3: is a third schematic perspective view of the machine for managing shoots of FIG. 1;

FIG. 4: is a fourth schematic perspective view of the machine for managing shoots of FIG. 1;

FIG. 5: is a perspective view of an elongate brush according to a third embodiment of the present invention;

FIG. 5a: is an enlarged view of detail A in FIG. 5;

FIG. 6: is a perspective view of the elongate brush of FIG. 5, showing the elongate brush in a partially assembled state;

FIG. 7: is a perspective view of an elongate brush according to a fourth embodiment of the present invention;

FIG. 8: is a side elevation view of the elongate brush of FIG. 7;

FIG. 9: is a diagrammatic end view of a vertical trellis and vine, illustrating the operation of the machine for managing shoots of FIG. 1;

FIG. 10: is a perspective view of a machine for managing shoots according to a fifth embodiment of the present invention;

FIG. 11: is a side elevation of the machine of FIG. 10;

FIG. 12: is a bottom view of the machine of FIG. 10;

FIG. 13: is a perspective view of another type of brush mounted on a sub-frame;

FIG. 14: is a perspective view of a drive shaft of the brush;

FIG. 15: is a side elevation view of the brush of FIG. 13; and

FIG. 16: is a perspective view of an adjustable arm that can be attached to the machine.

### DETAILED DESCRIPTION

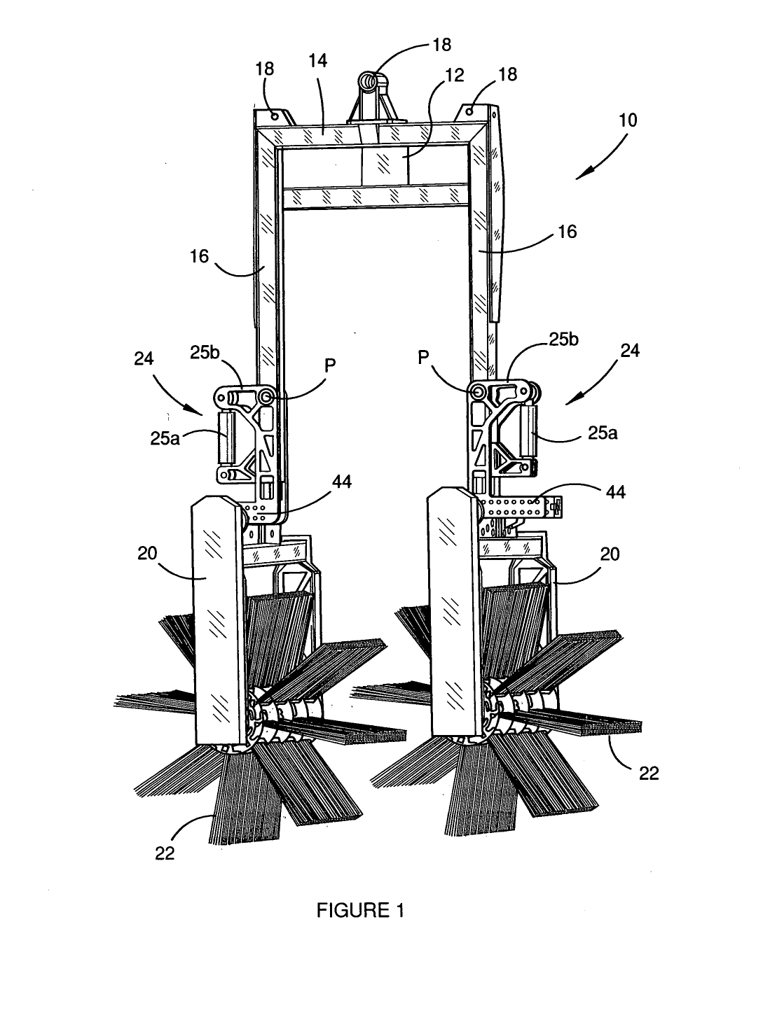

FIGS. 1 to 4 show a machine 10 for managing shoots from the cordon of vines arranged on a trellis. The term “managing” embraces thinning and/or removing shoots. The machine 10 has a frame 12, in the form of a crossbar 14 and two uprights 16, one depending from each end of the crossbar 14. Three attachment points 18 are provided on the crossbar 14. The attachment points 18 enable a vehicle, such as a tractor (not shown), to support and convey/transport the machine 10.

A sub-frame 20 is provided at the lower end of each upright 16. The sub-frames 20 each support an elongate brush 22. In use, the frame 12 straddles the trellis such that the elongate brushes 22 are on opposing sides of the cordon. Both elongate brushes 22 are arranged rotate along generally parallel axes in opposing directions to remove basal shoots from beside and/or beneath the cordon and/or shoots from the vine trunks. To achieve this, bristles 36 of the elongate brushes 22 contact the shoots and remove the shoots at their base.

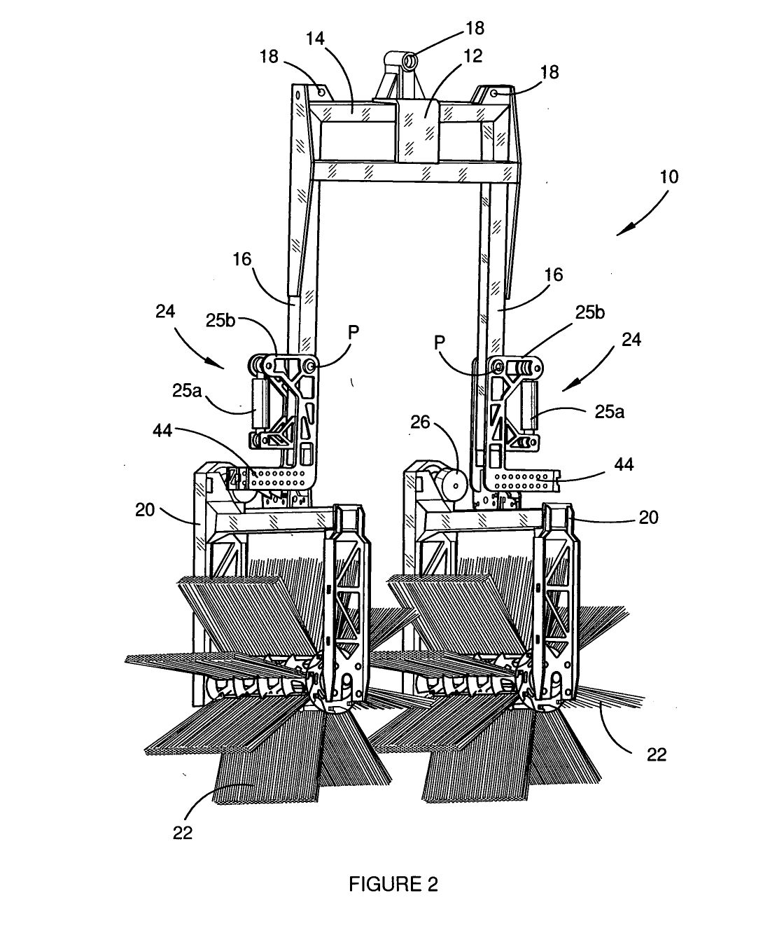

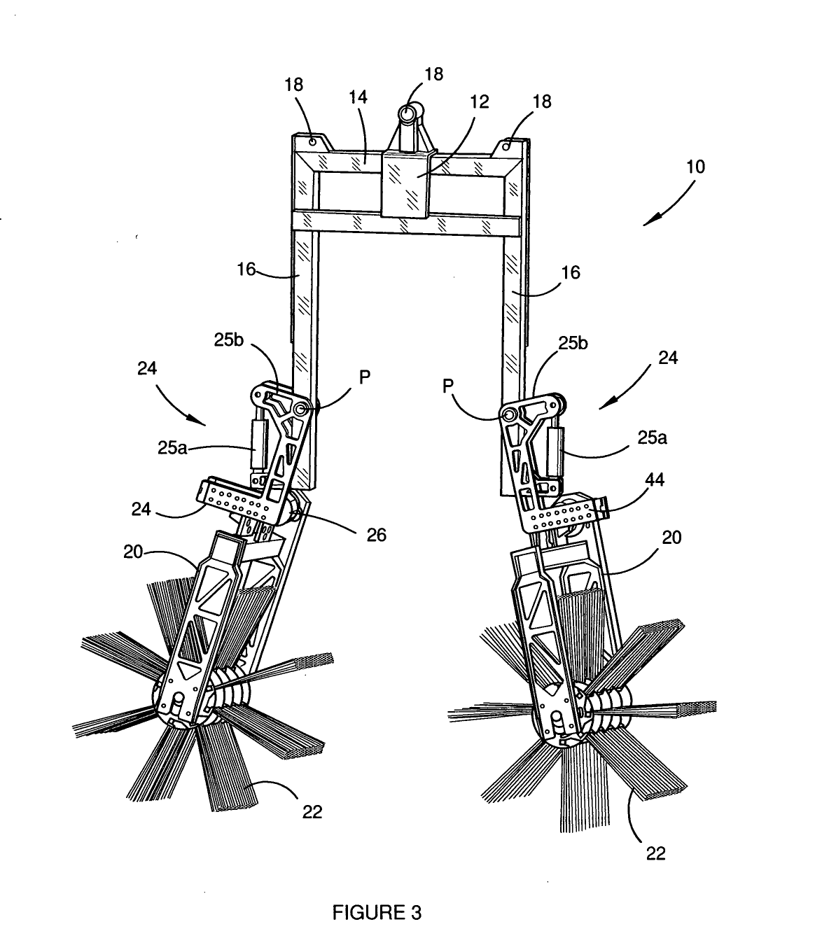

An actuator assembly 24 is provided at the lower end of each upright 16 to adjust the position of the respective elongate brush 22 relative to the upright 16. Each actuator assembly 24 has a linear actuator 25a and a bell crank 25b. To enable the adjustment of the position of the respective elongate brush 22 relative to the upright 16, each sub-frame 20 is attached to the respective bell crank 25b. Each linear actuator 25a can be operated to cause the respective sub-frame 20 and bell crank 25b to rotate about a first pivot point P to vary the separation of the two elongate brushes 22. The sub-frames 20 can be moved between a first position, as shown in FIGS. 1 and 2, and a second position, as shown in FIG. 3. Being able to adjust the separation of the elongate brushes 22 assists the operator as the machine 10 enters or exits the vine rows in the vineyard. In addition, the horizontal position of the elongate brushes 22 can be varied, whilst maintaining a constant separation of the elongate brushes 22.

Each bell crank 25b is provided with first adjustment mechanism 44, which supports the respective sub-frame 20. By adjusting the first adjustment mechanisms 44, the position of the sub-frames 20 on the bell crank 25b can be altered. Thus, an operator can select a desired separation of the sub-frames 20, and thus the elongate brushes 22, when the bell cranks 25b are in the first position. In other words, the minimum separation of the elongate brushes 22 can be selected.

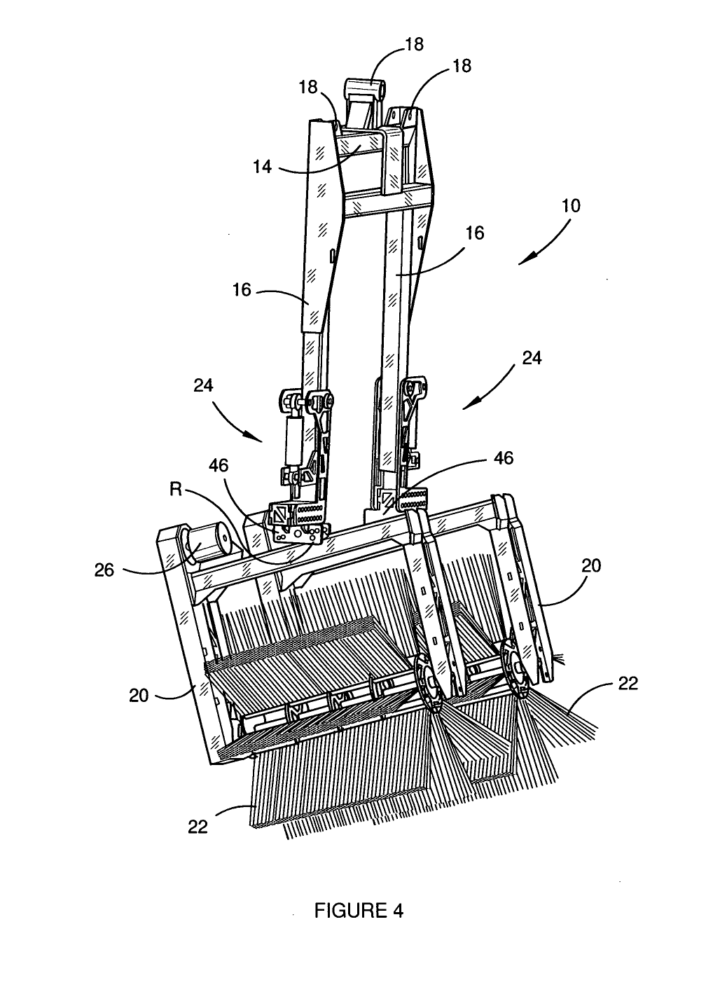

Each sub-frame 20 also has a second adjustment mechanism 46, which is most clearly seen in FIG. 4. Each second adjustment mechanism 46 allows the respective sub-frame 20 to be inclined relative to the upright 16. Accordingly, the inclination of each elongate brush 22 can be adjusted. The sub-frames 20 can each be rotated about a pivot from a level position, as shown in FIG. 1, and an inclined position, as shown in FIG. 4. By adjusting the second adjustment mechanism, an operator can select a desired inclination of the elongate brushes 22. Accordingly, an operator can select the amount of brush contact each elongate brush 22 has with the vine row.

Each sub-frame 20 also has a third adjustment mechanism which allows the sub-frame 20 to be pivoted outwards on a horizontal plane. By pivoting the sub-frame 20 outwards, the operator can select the amount of brush contact each elongate brush has with the vine cordon.

The machine 10 is provided with a drive mechanism or mechanisms that impart rotational motion to the elongate brushes 22. In this embodiment, the drive mechanism is in the form of two motors 26 that each drive a respective one of the elongate brushes 22. The motors 26 are arranged to drive the elongate brushes 22 in opposing directions. This can be such that the bristles of the elongate brushes 22 brush either generally upwardly or downwardly past the vines.

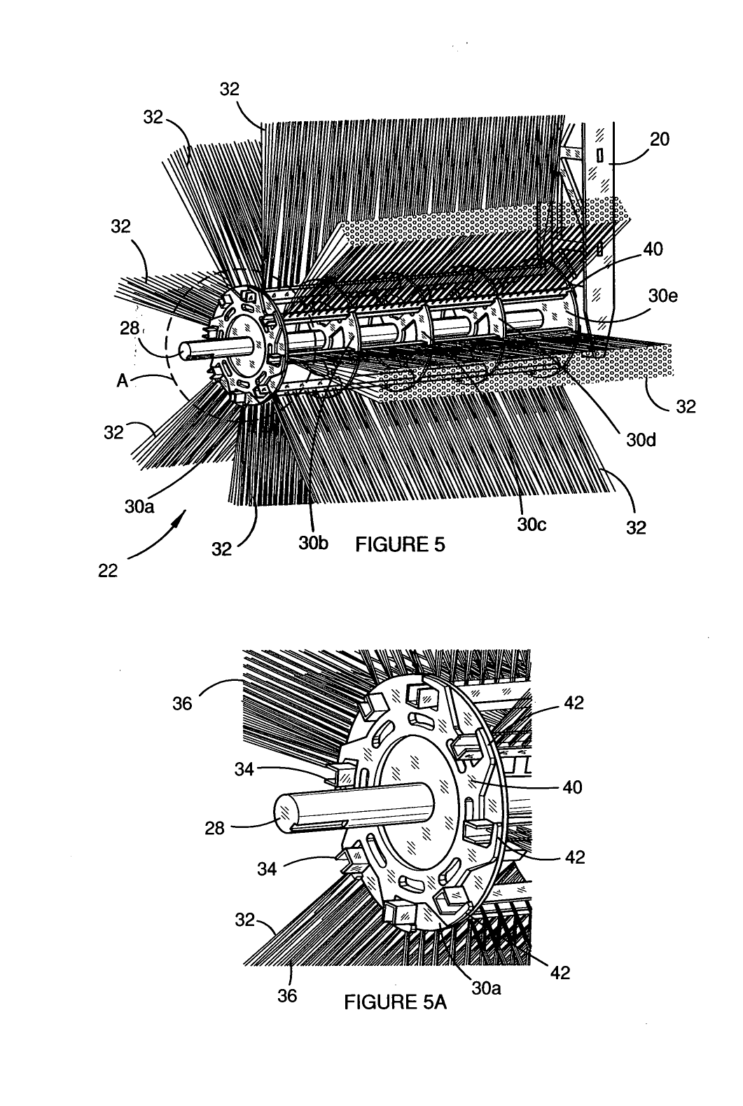

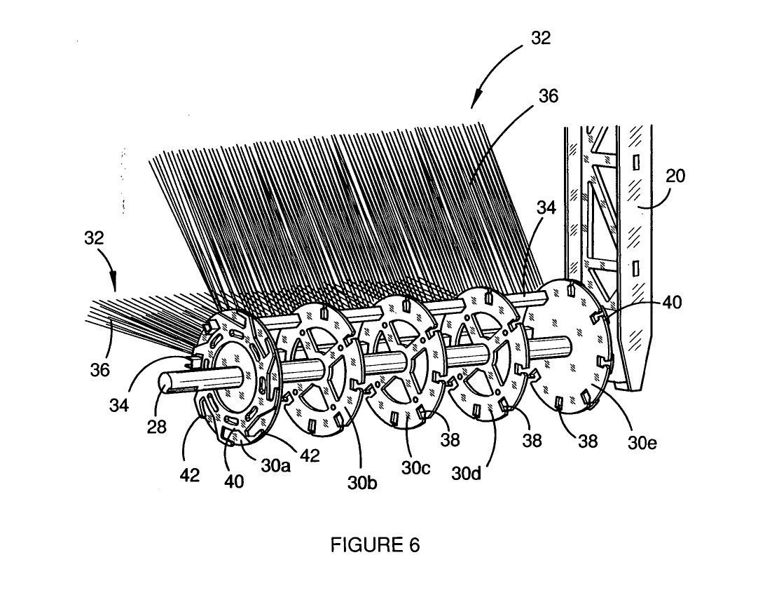

As shown in FIGS. 5, 5a and 6, the elongate brush 22 has a rotatable element, in the form of a shaft 28, about which the elongate brush 22 rotates. The shaft 28 is supported in the respective sub-frame 20 by bearings (not shown). One end of the shaft 28 is driven, either directly or indirectly, by the motor 26.

Each elongate brush 22 has mounts, in the form of five equally spaced discs 30a-30e (hereinafter referred to collectively as “discs 30”); two end discs 30a, 30e provided near the ends of the shaft 28, and three intermediate discs 30b, 30c, 30d disposed on the shaft 28 between the end discs 30a, 30e. The discs 30 are fixed on the shaft 28 such that they rotate with the shaft 28. Each elongate brush 22 has eight radially projecting bristle sets 32, which have an elongate bristle support 34 which extends across the discs and from which bristles 36 extend in a strip.

As best shown in FIG. 6, eight slots 38 are arranged around the periphery of each disc 30. Each slot 38 has an internal shape that complements the cross sectional shape of the bristle support 34, and a constricted opening at the periphery of the respective disc 30. Accordingly, the bristle supports 34 can be held in the slots 38 while the bristles 36 can extend outwardly of the discs 30, and through the constricted openings. The bristle support 34 is substantially restrained from rotating within the slots 38.

In this embodiment, the discs 30 are aligned such that slots 38 in the discs 30 are aligned linearly such that the bristle supports 34 are parallel with the rotational axis of the elongate brush 22. Each bristle set 32 can be installed or removed by sliding the bristle support 34 through the slots 38 in a direction parallel to the axis of rotation of the elongate brush 22.

The slots 38 on each disc 30 are spaced equiangularly such that the bristle sets 32 in the elongate brush 22 are also spaced equiangularly. As there are eight bristle sets 32 in this embodiment, the angle subtended between adjacent bristle sets 32 is approximately 45°.

To retain the bristle sets 32 in the discs 30, the end discs 30a, 30e are each provided with a locking ring 40 that can be rotated relative to the respective end disc 30a, 30e. As shown in FIG. 5a, the locking rings 40 have eight arcuate arms 42; one associated with each slot 38 on the respective end disc 30a, 30e.

Each locking ring 40 is movable between an open position and a closed position. When in the open position, the constricted openings of the slots 28 on the respective disc 30a, 30e are open, such that both the bristle supports 34 and bristles 36 can be slid through the slots 38. When the locking rings 40 are in the closed position, the arcuate arms 42 obstruct the constricted openings of the slots 28. With the locking rings 40 in closed position, the arcuate arms 42 inhibit the passage of bristles 36 through the constricted opening. Thus, the bristle sets 32 can be effectively locked in place between the end discs 30a, 30e. As the bristle sets 32 wear during use they can be removed and replaced.

In this embodiment, the separation of the end discs 30a, 30e, in the direction parallel to the rotational axis of the shaft 28, is greater than, or equal to, the length of the strip of bristles 36 of each bristle set 32. In addition, the bristle support 34 of each bristle set 36 is longer than the separation of the end discs 30a, 30e.

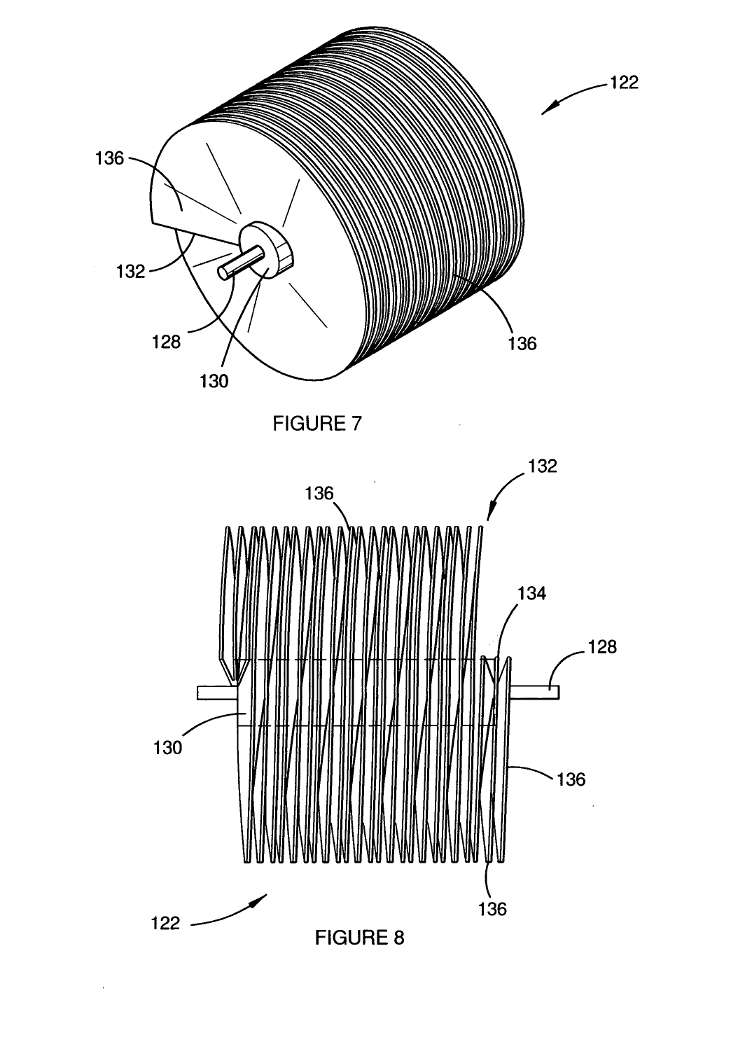

FIGS. 7 and 8 show an elongate brush 122 according to a fourth embodiment of the present invention. The elongate brush 122 has a rotatable element, in the form of a shaft 128, about which the elongate brush 122 rotates, and a mount, in the form of a drum 130 supported by the shaft 128.

The elongate brush 122 has a single bristle set 132, which has a bristle support 134 from which bristles 136 extend in a strip. The bristle support 134 is wound helically around the drum 130, and attached by, for example, welding. As the bristle support 134 is helically shaped, the bristles 136 also have a helical shape.

The number of turns and the pitch of the bristle support 134 can be selected as desired. In this embodiment, eight turns of the bristle support 134 are provided about the drum 130, at a pitch of approximately 75 mm.

The direction of helix can be either left handed or right handed. However, the person skilled in the art will appreciate that the direction of helix for the two elongate brushes 122 in the pair mounted on a machine for thinning and/or removing shoots should be opposing. This will minimize the generation of a moment (by the pressure of the bristles 136 on the vine) that attempts to cause the machine to rotate about a vertical axis.

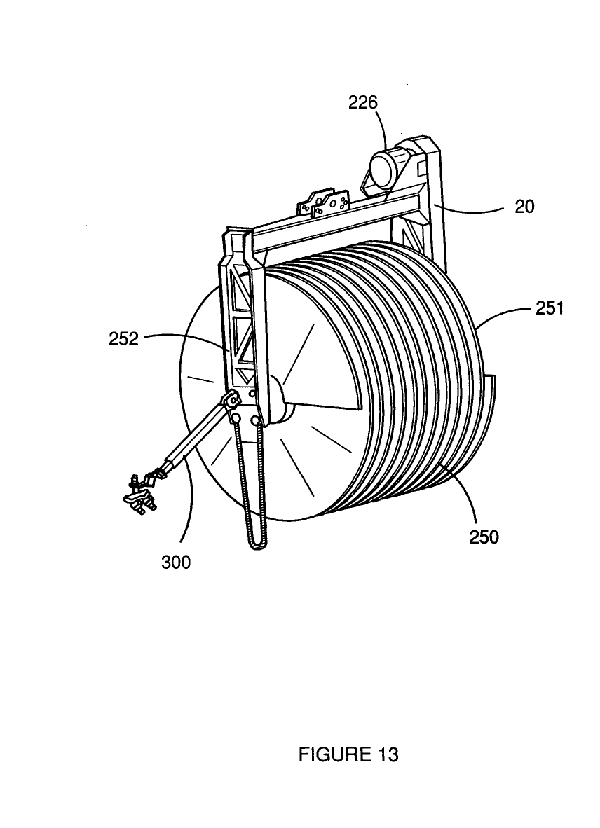

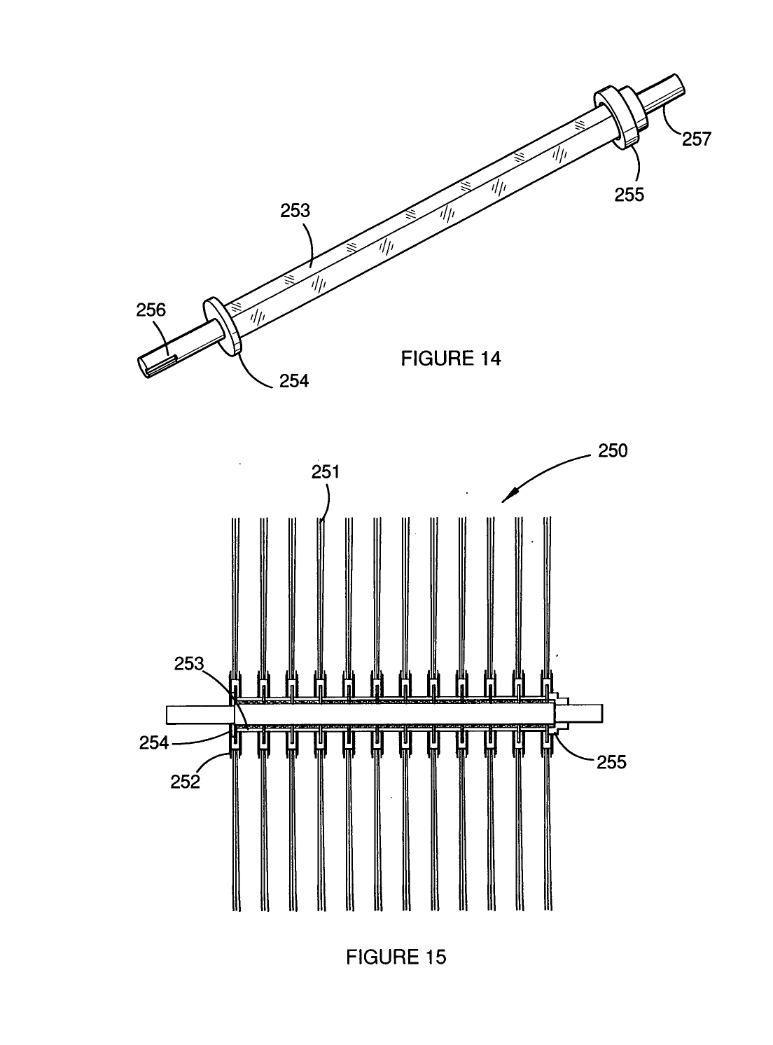

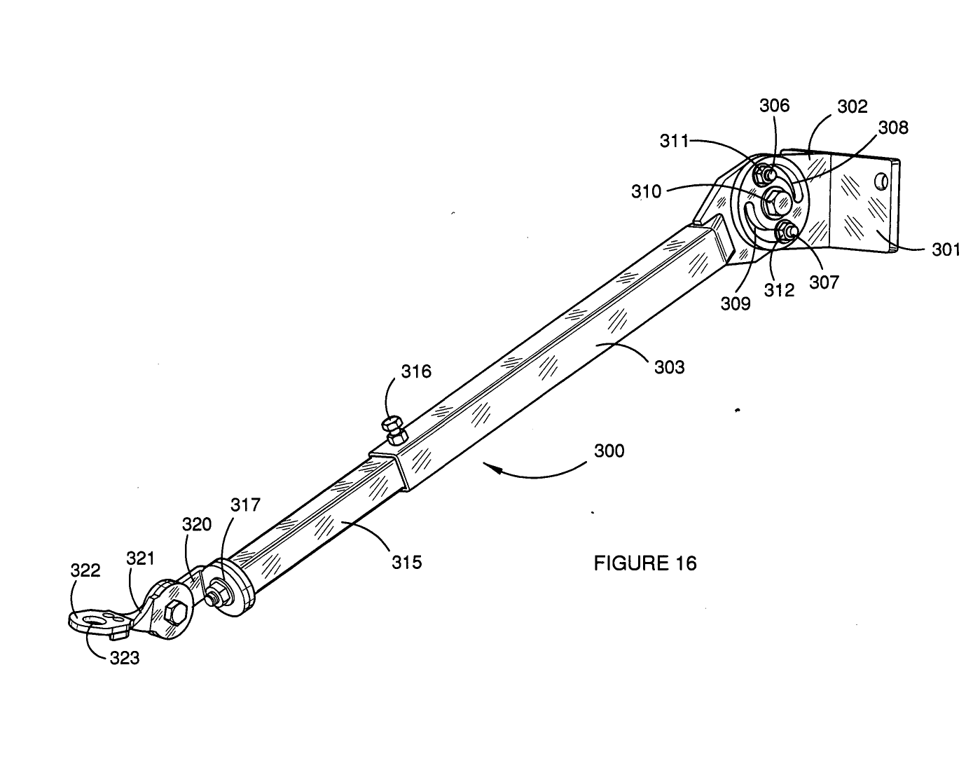

In another embodiment shown in FIGS. 13 to 15, each sub-frame 20 supports a conventional road brush 250 that is in the form of twelve brush sections 251 extending radially from a central hub 252. Each brush section 251 is disc-shaped and mounted on a square drive shaft 253 with appropriate spaces to ensure that the brush sections 251 are equally spaced coaxially along the shaft 253. The shaft ends in a fixed end plate 254 at one end and a removable end plate 255 at the other. The shaft has cylindrical ends 256, 257 that are keyed to an appropriate drive mechanism. In the preferred embodiment, the brushes 250 have an overall diameter of 760 mm and a suitably squared fitting is positioned centrally of the circular centre section of the disc-shaped brush section 251 for mounting on the square drive shaft 253.

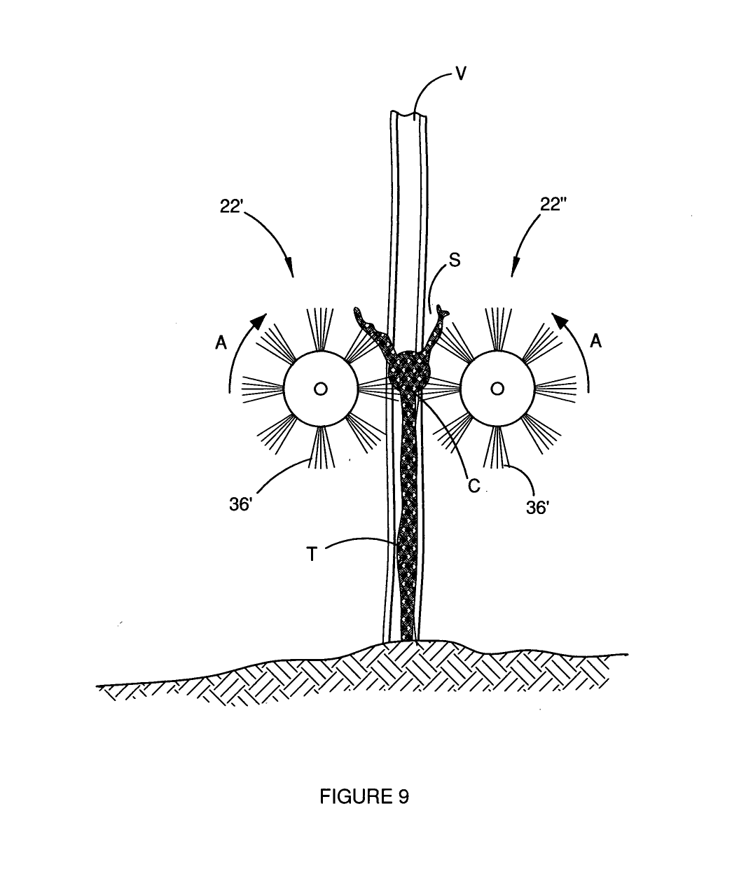

FIG. 9 shows diagrammatically the operation of the machine for thinning and/or removing shoots according to the present invention. Two elongate brushes 22′ are shown in end view, positioned on either side of a row V of vines positioned on a trellis. A vine trunk T rises from the ground surface to a cordon C. Spurs S extend from the cordon C. As indicated by arrows A, the elongate brushes 22′ rotate in opposite directions such that the bristles 36′ brush downwardly past the cordon C, contacting and removing shoots (not shown) on the sides of and/or below the cordon C and/or on the trunks T. Alternatively, the elongate brushes 22′ can rotate in opposite directions such that the bristles 36′ brush upwardly past the cordon C. It is to be appreciated that if the elongate brushes 22′ rotated in one direction the machine would attempt to “climb” the trellis.

The diameter of each elongate brush is within the range of 200 mm to 900 mm. In the embodiment illustrated in FIGS. 5, 5a and 6, the diameter of the elongate brush 22 is approximately 750 mm, with the length of the bristles 36 being approximately 300 mm. The overall length of each elongate brush 22 can be in the range of 200 to 1000 mm.

The bristles 36, 136 do not need to contact the cordon C to effectively remove shoots at their base, which is at the cordon C. Indeed, during trials it has been observed that it is possible to effectively remove shoots at their base when the tips of the bristles 36, 136 are at distances from the cordon C up to approximately 25% of the average shoot length.

It will be appreciated that there are many factors that affect the effectiveness of the machine 10. One important factor is the pressure applied by the bristles 36 on the shoots. Insufficient pressure may result in shoots being damaged rather than removed. Excessive pressure may result in the vine itself being damaged. The amount of pressure applied by the bristles 36 is influenced by the stiffness and length of the bristles 36 as well as the rotational speed of the elongate brushes 22.

Another important factor is the amount of brush contact on the vines. This is influenced by the size of the elongate brush (that is, the length and diameter of the elongate brush); the profile of the elongate brush, which can be adjusted using the second adjustment mechanism 46; the ground speed of the machine; and the rotational speed of the elongate brushes.

The machine can be provided with a control system (not shown) for detecting the location of the cordon as the machine advances along the vine row. By operating the actuator assembly, the horizontal position of the elongate brushes can be adjusted in response to variations in the position of the cordon and/or the presence of trellis posts, etc. The control system can be provided with sensors and a controller for operating the actuator assemblies to adjust the position of the elongate brushes relative to the frame.

In addition, the control system can detect the ground speed of the machine for thinning and/or removing shoots. The motors can be controlled to vary the rotational speed of the elongate brushes in response to variations in the ground speed of the machine.

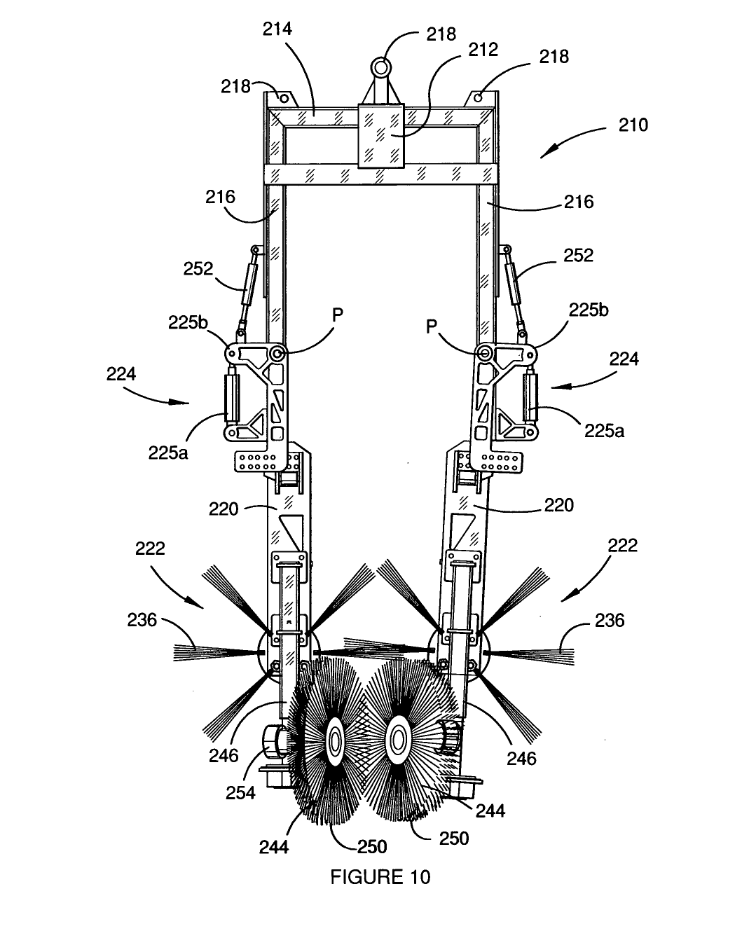

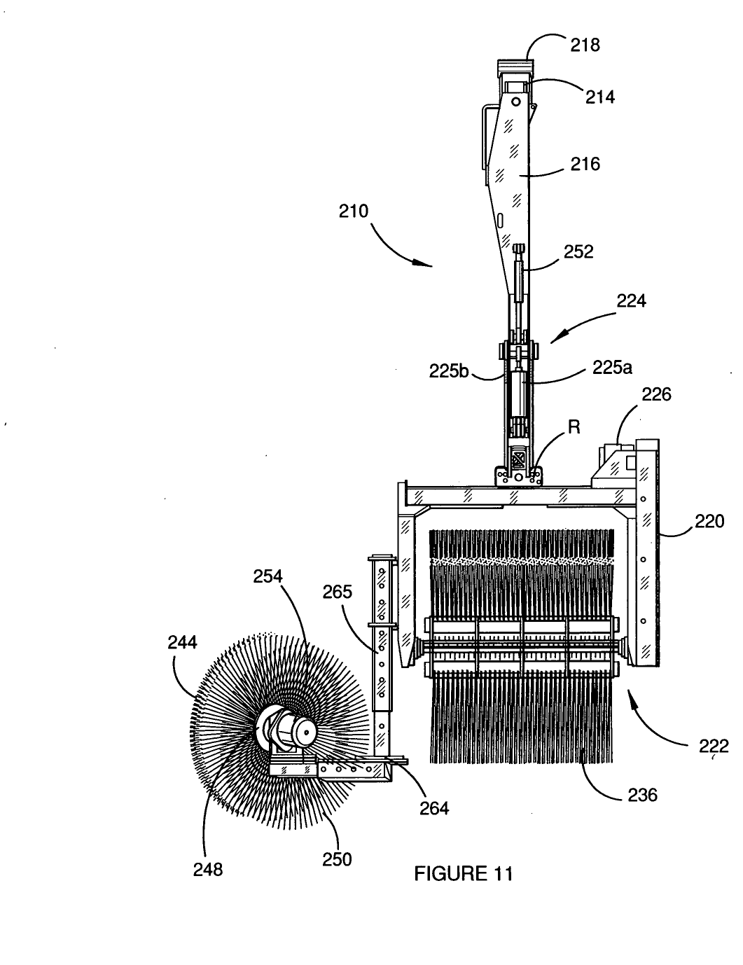

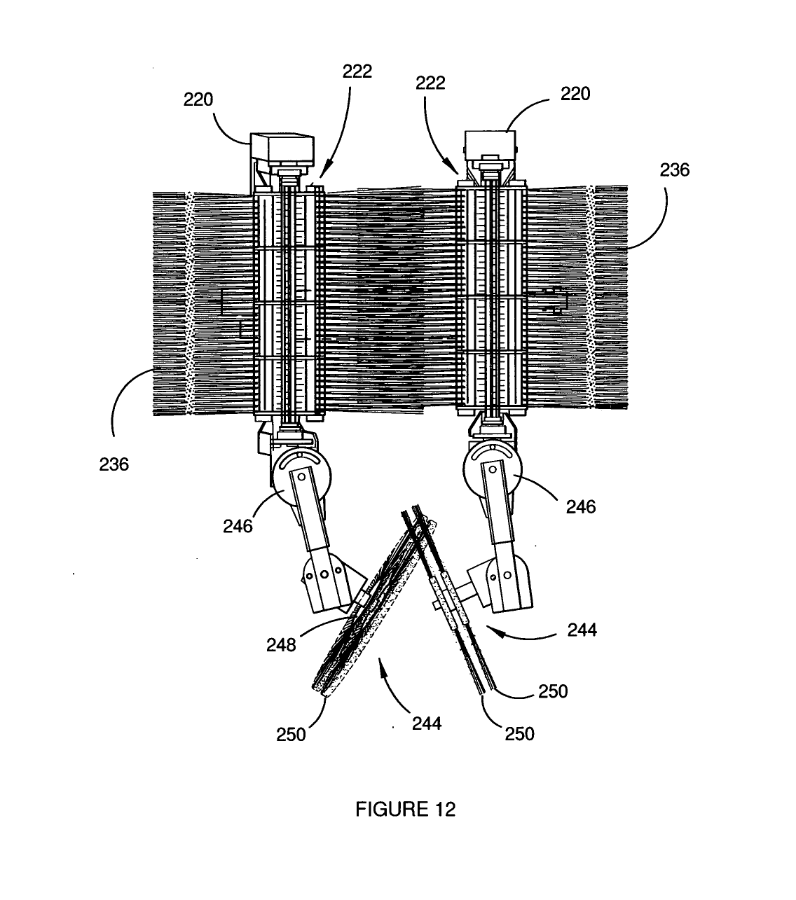

FIGS. 10 to 12 show a machine 210 for thinning and/or removal of shoots according to a fourth embodiment of the present invention. The machine 210 has a frame 212, in the form of a crossbar 214 and two uprights 216, one depending from each end of the crossbar 214. Three attachment points 218 are provided on the crossbar 214. The attachment points 218 enable a vehicle, such as a tractor (not shown), to support and convey/transport the machine 210.

A sub-frame 220 is provided at the lower end of each upright 216. The sub-frames 220 each support an elongate brush 222. In use, the frame 212 straddles the trellis such that the elongate brushes 222 are on opposing sides of the cordon. Both elongate brushes 222 are arranged rotate along generally parallel axes in opposing directions to remove basal shoots from beside and/or beneath the cordon and/or the vine trunks. To achieve this, bristles 236 of the elongate brushes 222 contact the shoots and remove the shoots at their base.

The machine 210 has two generally disc-shaped brush 244 for removing shoots (also known as suckers) from vine trunks. Each brush 244 is supported on the end of an arm 246 that is attached to the respective sub-frame 220. Each brush 244 rotates in a plane that is perpendicular to the ground surface and at an angle to the trellis. The disc-shaped brush 244 has a hub 248 from which bristles 250 extend in a generally radial direction.

The disc-shaped brushes 244 are rotated as the machine 210 advances along the trellis, the bristles 250 contacting and removing shoots from the vine trunks. Accordingly, removal of shoots from beside and/or beneath the cordon (by the elongate brushes 222) on the two opposing sides of the trellis, as well as removal of suckers from the vine trunks (by the disc-shaped brushes 244) can be effected in a single pass of the machine 210 along a trellis.

In this embodiment, the disc-shaped brushes 244 are positioned below the elongate brushes 222, and behind the elongate brushes 222 with respect to the forward direction of the machine 210. However, in alternative embodiments the disc-shaped brushes 244 are positioned in front of the elongate brushes 222 with respect to the forward direction of the machine 210. Rotational motion can be imparted to the disc-shaped brushes 244 by drive mechanisms, such as motors 254, that are independent of the motors 226 that drive the elongate brushes 222. Alternatively, a linkage can be provided to transfer rotational motion from the motors 226 to the disc-shaped brushes 244.

An adjustment mechanism 256 is provided to allow the operator to vary the length of the arm 246, and thus the vertical position of each disc-shaped brushes 244 relative to the respective sub-frame 220.

An actuator assembly 224 is provided at the lower end of each upright 216 to adjust the position of the respective elongate brush 222 relative to the upright 216. Each actuator assembly 224 has a linear actuator 225a and a bell crank 225b. To enable the adjustment of the position of the respective elongate brush 222 relative to the upright 216, each sub-frame 220 is attached to a respective bell crank 225b.

Each linear actuator 225a can be operated to cause the respective sub-frame 220 and bell crank 225b to rotate about a first pivot point P to vary the separation of the two elongate brushes 222. The sub-frames 220 can be moved between a first position mutually outwardly towards a second position. Being able to adjust the separation of the elongate brushes 222 assists the operator as the machine 210 enters or exits the vine rows in the vineyard. In addition, the horizontal position of the elongate brushes 222 can be varied, whilst maintaining a constant separation of the elongate brushes 222.

In this embodiment, the linear actuators 225a are in the form of a hydraulic cylinder and a hollow piston, which has a slippered piston rod. Accordingly, the piston rod can be moved in or out of the piston independently of hydraulic pressure. During operation of the machine, it is possible that the elongate brushes may approach too closely to the trellis. Having a slippered piston rod arrangement allows the elongate brush to move outwardly of the trellis. Thus, the machine is provided with a form of safeguard against damage.

The machine 210 has two gas springs (also known as gas struts 252) that are each attached at one end to an upright 216, and at the other end to the respective bell crank 225b. Each gas strut 252 biases the respective sub-frame 220 towards the first position. Therefore, if one of the elongate brushes is moved outwardly, the gas strut 252 will urge the sub-frame 220, and thus the elongate brushes 222 and the disc-shaped brush, toward the first position.

In an alternative embodiment shown in FIG. 13 to 15, the machine has a pair of adjustable arms 300 designed to hold a range of spray nozzles, allowing the application of a debudding chemical to remove shoots from the base of the trunks. These arms can be adjusted in length and angle in relation to the ground. A further two planes of rotation are available at the spray nozzle mounting bracket.

As shown in FIG. 15, the adjustable arm assembly 300 comprises a end bracket 301 which is bolted to the arm of the sub-frame 20. The end bracket 301 has a flange 302 that is bolted to the flanged end of an outer conduit 305. A pair of bolts 306, 307 extend in arcuate slots 308, 309 on either side of the mounting point 310 and a pair of lock nuts 311, 312 can be tightened to adjust the inclination of the outer conduit 303 relative to the flange 302. The outer conduit 303 supports an inner conduit 315 that can slide in and out of the outer conduit 303 and adjusted by means of a lock nut 316. The internal conduit 315 terminates in an end flange 317 onto which is bolted a right angle bracket 320 which in turn pivotally supports a twisted bracket 321 terminating in a flange 322 with a central aperture 323. This flange is arranged to support the jet nozzle (not shown). The arm 300 can be thus adjusted in length and angle relative to the sub-frame 20, the arm also provides a further two planes of rotation at the spray nozzle.

It will be understood to persons skilled in the art of the invention that many modifications may be made without departing from the scope of the invention.

It will be appreciated that the machine can be provided with brushes for removing shoots from beside and/or beneath the cordon of the vine or brushes for removing shoots from the trunk of the vines, or both.

It will be appreciated that the machine according to the present invention can be employed for a number of activities in a vineyard. For example, the machine may be provided with elongate brushes having relatively soft bristles, such that the machine can be employed for de-flowering. In one further alternative, the machine may be provided with stiffer bristles, such that the machine can be employed for cane flicking; that is, flicking canes from within the canopy after the canes have been pruned.

For example, alternative embodiments of the elongate brush could be in the form of a drum mounted on a shaft, the drum having bristles that extend radially outward. The bristles may be evenly dispersed over the outer circumferential surface of the drum. Alternatively, the bristles may be arranged in strips, clusters or other patterns.

The bristles may be made of a relatively stiff, elongate fibrous material. Alternatively, the bristles may be made of a pliable and/or drooping elongate material such that, in use, the bristles are flailed.

In embodiments similar to that illustrated in FIGS. 5, 5a and 6, any number of sets of bristles may be employed. However, it will be appreciated that for rotational balance reasons the minimum number of sets of bristles is preferably two. In the embodiment illustrated in FIGS. 5, 5a and 6, the slots 38 are arranged linearly. However, in alternative embodiments the slots can be offset in adjacent discs such that the slots of the elongate brush are aligned helically. Each bristle set is then helical in its arrangement.

Alternative embodiments of the elongate brushes may be provided, in which the locking ring takes an alternative form, whilst still restraining the bristle support from moving radially with respect to the shaft and discs. For example, the locking ring and one of the end discs may be combined to form a combined locking ring and end disc. In such an embodiment the bristle sets are first inserted into slots in the other discs. Subsequently, the combined locking ring and disc is fitted to the shaft and the bristle sets. The combined locking ring and disc may be held in place by a keyed and/or threaded portion of the shaft.

Persons skilled in the art will appreciate that for the effective thinning and/or removal of basal shoots beside and/or beneath the cordon, a correlation exists between the speed of advancement of the elongate brushes along the vine row (that is, the ground speed) and the rotational speed of the elongate brushes. For example, early trials indicate that for ground speeds of approximately 3 km/h, the ideal rotational speed of the elongate brushes is in the range of 150 to 700 rpm.

In some alternative embodiments of the machine for thinning and/or removing shoots, the actuator assembly can additionally be operated to adjust vertical height of elongate brushes by displacing the respective sub-frame relative to the associated upright. Accordingly, in such an embodiment, the elongate brushes can be moved, relative to the respective upright, in horizontal and vertical planes, as well as the inclination being adjusted. It will be appreciated that the movement of elongate brushes can be controlled individually, or such that the elongate brushes are moved symmetrically and in mirror image about a centre-line of the machine.

In alternative embodiments, each sub-frame may have telescoping arms that at one end support the respective elongate brush. The opposing end of the telescoping arms may be supported by a rotary actuator to adjust the rotational position of the telescoping arms relative to the frame.

The machine for thinning and/or removing shoots may be supported either in front of or behind a transport vehicle, such as a tractor. In an alternative embodiment, the machine for thinning and/or removing shoots may be self supported and drawn by a vehicle. Alternatively, the machine for thinning and/or removing shoots may be both self supported and self propelled.

The drive mechanism for the elongate brushes may take many forms. For example, in an embodiment in which the machine is self supported and drawn by another vehicle, rotational motion of the machine's own wheels may be used to drive the elongate brushes. In some embodiments, a gear train may be provided between each motor and the respective elongate brush 22. Such a gear train can be arranged to provide a 1:1 ratio. Alternatively, such a gear train can be arranged to provide either reduction or step-up, such that motors 26 can be run within an optimal operating speed range while the elongate brushes 22 are also rotated within an optimal speed range.

In the claims of this application and in the description of the invention, except where the context requires otherwise due to express language or necessary implication, the words “comprise” or variations such as “comprises” or “comprising” are used in an inclusive sense, i.e. to specify the presence of the stated features but not to preclude the presence or addition of further features in various embodiments of the invention.

Having now discussed my invention, what I claim is:

1. A machine for managing shoots of vines arranged on a trellis, the machine comprising:
a frame that has two spaced apart uprights, the frame being arranged to straddle the trellis, each upright supporting a brush that is rotatable to contact shoots extending from the vines; and
a drive mechanism for imparting rotational motion to each brush, such that, in use, the brushes rotate on opposing sides of the trellis to contact and remove shoots from the vine as the machine is advanced along the trellis.

2. The machine according to claim 1 wherein the brushes are arranged to rotate in opposite directions.

3. The machine according to claim 1 wherein the brushes each comprise an elongate brush that is rotatable about an axis which is substantially parallel to the trellis.

4. The machine according to claim 3 wherein a sub-frame is pivotally connected to each upright, each sub-frame supporting one of the elongate brushes, such that pivotal movement of the sub-frame causes the brush to pivot away from the vines.

5. The machine according to claim 4 wherein an actuator causes the sub-frame to pivot relative to the upright.

6. The machine according to claim 5 wherein the actuators can be operated independently of one another.

7. The machine according to claim 6 wherein each actuator can be operated to adjust the vertical position of the respective elongate brush relative to the respective upright.

8. The machine according to claim 1 wherein two disc-shaped brushes are supported on an arm that is connected to the frame, the brushes being arranged to thin suckers around the vine trunk between the cordons.

9. The machine according to claim 8 wherein the disc-shaped brushes are in the form of bristles that extend radially from a hub.

10. The machine according to claim 8 wherein each disc-shaped brush can be rotated in a plane that is approximately perpendicular to the ground surface.

11. The machine according to claim 10 wherein the plane can be at an angle to the trellis.

12. The machine according to claim 1 wherein the machine has a control system that senses the position of the cordon and operates the actuators to adjust the horizontal position of each brush relative to the respective upright, in response to changes in the position of the vines and/or trellis.

13. The machine according to claim 12 wherein the control system senses the inclination of the cordon and operates the actuators to adjust the vertical position of the rotation of each brush in response to changes in the vine and/or trellis height.

14. The machine according to claim 13 wherein the control system senses the ground speed of the machine and adjusts the rotational speed of the elongate brushes in response to the changes in the ground speed.

15. An elongate brush for thinning shoots from the cordon of a vine, the brush comprising:
a rotatable shaft supporting a plurality of mounts connected spaced apart to the shaft, the mounts providing support for a plurality of bristle sets each having bristles that extend from a bristle support,
wherein the bristle supports are releasably connected across the mounts and parallel to the shaft.

16. The brush according to claim 15 wherein the mounts comprise discs positioned along the shaft, wherein the bristle sets are supported by the periphery of the discs.

17. The brush according to claim 16 wherein the periphery of each disc is provided with a plurality of spaced apart slots for supporting the bristle supports of the bristle sets, wherein the slots in the discs are aligned to receive the bristle support.

18. The brush according to claim 17 wherein the bristle support of each bristle set can be slid into the slots.

19. The brush according to claim 18 wherein each slot has a constricted opening at the periphery of the respective disc, such that the bristles of the bristle set are able to extend through the constricted opening.

20. The brush according to claim 15 wherein a locking ring is mounted on one end of the shaft to be moveable between open and closed positions, wherein when the locking ring is in the open position the bristle supports can be slid out of the slots.

21. The brush according to claim 20 wherein the locking ring has an arcuate arm associated with each slot on the respective end disc, which extends across a portion of the respective slot, when the locking ring is in the closed position.

22. A brush comprising a rotatable shaft supporting an elongate bristle support helically wound around and secured to the shaft, the bristle support supporting an elongate array of laterally extending bristles.
